(19) United States
(12) Patent Application Publication
(10) Pub. No.: US 2020/0300080 A1
(43) Pub. Date: Sep. 24, 2020

(54) System comprising a ground drilling device, method of controlling an operation of a ground drilling device and use of a ground drilling device

(71) Applicant: TRACTO-TECHNIK GmbH & Co. KG, Lennestadt (DE)

(72) Inventor: Wolfgang Schmidt, Kirchhundem (DE)

(21) Appl. No.: 16/788,717

(22) Filed: Feb. 12, 2020

(30) Foreign Application Priority Data
Feb. 15, 2019 (DE) 10 2019 001 108.2

(51) Int. Cl. E21B 47/09; E21B 7/04; E21B 47/12

(52) U.S. Cl. CPC E21B 47/09; E21B 7/02; E21B 47/12; E21B 7/046

(57) ABSTRACT

A system comprising a ground drilling device for moving a drill string for the insertion of an earth borehole into the ground, wherein a detection device is provided which is designed to detect the drill string at the end (a) in the region of the ground drilling device and/or (b) in the region of a target pit of the earth borehole to be created.

### FIELD OF INVENTION

The invention concerns a system comprising a ground drilling device, a method of controlling an operation of a ground drilling device and a use of a ground drilling device.

### BACKGROUND

Ground drilling devices are regularly operated by several operators. In particular, an operator is required in an operators station, which is usually designed as an operators cabin. An additional operator is usually present in the end region of a drill pipe, who controls the proper operation, wherein the end region of the drill pipe can be understood as the starting pit and/or the target pit. The end region can thus be the area where the drive drives the drill string into the ground and/or where the drill head emerges from the ground.

### SUMMARY

The problem of the invention is therefore to create a system, a method and a use with which the effort required to drill the borehole by means of the ground drilling device can be reduced, in particular the effort in the form of providing a smaller number of operating and/or monitoring personnel.

The key idea of the invention is to provide a detection device which is adapted to detecting the drill string at the end (a) in the area of the ground drilling device and/or (b) in the area of a target pit of the earth borehole to be created. The provision of such a detection device makes it possible for the operator, who was previously considered necessary in this position, to choose his location more freely. The operator designated for the previous monitoring no longer necessarily has to stay in the area and can change the location and/or the scope of duties. For example, the tasks previously performed by the operator supervising the end section of the drill pipe can be taken over by the operator in charge of controlling the ground drilling device. Since the activity can now be carried out by the operator otherwise in charge of the control, the previously required additional operator can be assigned to other tasks, thus reducing the personnel and/or the cost of providing personnel for the installation of a ground drilling device. An additional benefit for the company using the ground drilling device is possible.

The invention creates a system comprising a ground drilling device for moving a drill string for drilling an earth borehole in the ground. The system also has a detection device which is designed to detect the drill string at the end (a) in the area of the ground drilling device and/or (b) in the area of a target pit of the earth borehole to be created.

For the purposes of the description, a “ground drilling device” is any device which, in particular, moves a drill string having rod sections in an existing or yet to be created conduit in the soil, in order to create or widen a borehole, in particular a horizontal borehole (HD), or to draw pipelines or other long bodies into the soil. The ground drilling device may in particular be a HD device. The term “HD” (horizontal drilling) in the sense of the present description encompasses in particular an at least partly horizontal borehole or conduit or pipeline. A ground drilling device can thus be a device driving a drill string operating by displacing earth, and introducing the drill string into the ground in a translational and/or rotational manner in the longitudinal axial direction of the drill string. A borehole can be introduced into the soil by pulling or pushing on the drill string. For the purposes of the description, the term “rod section” does not exclusively encompass rigid, individual force transmitting elements which can be directly or indirectly connected to each other and that can be used in a ground drilling device.

A front-end section of the drill string may be configured as a drilling head or drilling tool. In addition, the drill string may have a probe housing, particularly in a front-end region.

For the purposes of the description, a “detection device” includes any device designed to detect the presence of a drill string, in particular an end of a drill string or a rod section or a drill head in an area. The detection device may be designed as a device which detects a change in the presence of the end of a drill string or rod section or the drill head.

For the purposes of the description, the term “end of the drill string in the area of the ground drilling device” encompasses in particular the section of the drill string which is or comes into contact with the drive of the ground drilling device, which is configured to introduce the drill string into the earth. In this area, it is regularly planned to change the drill string in order to lengthen or shorten the drill string by means of a further rod section. Changing the drill string may require special attention from an operator, as, for example, the already drilled drill string can be clamped to compensate for tensile and/or compressive forces exerted on the drill string. For the purposes of the description, the term “end in the region of a target pit of the earth borehole to be drilled” encompasses the area in which a drill string emerges from the ground, in particular with the front drilling head or drilling tool. Usually, the drill string emerges from the ground into a target pit, whereby the term “target pit” in the sense of the description is to be understood as any area into which the drill string is planned to emerge from the ground. The area does not necessarily have to be designed as a “pit”; the term “target pit” refers to the fact that this area is specifically targeted as an exit from the ground. The term “target pit” also includes intermediate positions from which the borehole can be extended and/or continued.

In a preferred embodiment, the detection device is a camera, zone scanner and/or motion scanner, which allows the use of known devices, their handling and use, although common for other fields.

For the purposes of the description, a camera is any device that takes an image of an area, in particular the image can be displayed on the display device. For this purpose, the display device may display the signals or information from the camera on at least part of the display device. The signals may be displayed directly or may be processed by the control unit of the display device and/or the control device of the ground drilling device before they are displayed.

For the purposes of the description, a zone scanner is a device that can detect or determine a change in the presence of an area. The zone scanner can be designed as a light barrier, light curtain or similar. The zone scanner can be designed using ultrasound, electromagnetic radiation in the infrared range or radar waves.

For the purposes of the description, a motion scanner is a device that can detect or determine motion in an area.

Both the zone scanner and the motion scanner can be used to generate a signal when motion or intrusion into an area is detected in any form. This signal can be transmitted to an electronic or electrical device. It may be provided that a signal from a zone scanner or motion scanner is transmitted to a display device, for example, and thus a “response” of the zone scanner and/or the motion scanner is displayed on a display device. It may be provided that as soon as the zone scanner and/or the motion scanner have detected an intrusion of an object into the area and/or a movement in an area, an image of a camera is displayed on a display device, wherein the camera is present at the end area of the ground drilling device and/or end area of a target pit of the earth borehole to be created. This means that—at least in a preferred embodiment—the display of an image from a possibly existing camera can be carried out after a zone scanner and/or motion scanner has detected a change or presence of the end of a drill string or rod section or of the drilling head.

In a preferred embodiment, a display device is provided for displaying a state detected by the detection device, wherein the detection device comprises a transmitter and the display device comprises a receiver, and the display device is adapted to process signals for representing the state detected by the detection device. The detection device can thus have transmission means which are designed to transmit signals to the display device, the display device being designed to process the signals of the detection device in such a way that the signals can be displayed on the display device for an operator. The signal(s) may be transmitted directly between the detection device and the display device. However, it may also be provided that the detection device transmits a signal indirectly to the display device. For example, the detection device may transmit the signal to a control device of the ground drilling device and the control device may transmit the signal unchanged or processed to the display device. A large degree of flexibility can be created.

For the purposes of the description, “display device” means any device capable of visualizing the signal from the detection device. The display device may in particular be an electrical or electronic display, which may in particular be a liquid crystal display (LCD), light emitting diode (LED) matrix display, fluorescent display (VFD) or similar. In particular, the display device can be used to display images in a way that is particularly intuitive and easy to understand. The display device may be a universal display instrument in the form of a screen, monitor, display, tablet, notepad, IPAD, smart display, smart phone or similar. The display device can be used to visualize the operation of the ground drilling device with regard to at least one parameter. The operator can carry the display device with him on site. However, the display device may also be located in an operator's station.

In particular, the display device may include a processor which is designed as an arithmetic unit with electronic circuits to execute instructions. The processor can be programmed and is designed to process commands. The display device may have an operating system which for example may be modified to improve and/or adapt to changes for communication with the detection device or display. In particular, a change of the operating system can only be permitted if a password has been entered and/or the display device is connected to a computer interface, a dongle or similar. In particular, the processor can recognize, query, process, pass on and/or process further commands of a program by querying which parameters, if necessary in which form of display, are to be displayed. The processor can run a program that requests or receives operator input, processes the operators input, and then displays the parameters and/or signals after retrieving parameters from the control device and/or signals from the detection device, as appropriate. The indicator may have a portable power supply, in particular in the form of one or more batteries, accumulators or similar.

The display device may allow the input of parameters, functions and/or changes in the display on the display device which—if the display device has a touch-sensitive display—may be made as so-called inputs by touching, tapping, stroking or similar means. However, it is also possible, alternatively or additionally, that inputs to the display device may be enabled by means of an integrated device or an additional connectable device (e.g. by means of a cable connection, and/or wirelessly, e.g. via Bluetooth). The integrated or additional device may be a mechanically actuated actuating element (e.g. a push button, rocker key), a keyboard, a mouse, a trackball, a graphics tablet, a microphone, a camera or a similar input device, in particular in the form of a peripheral device otherwise known in the computer field, which allows key or write inputs, audio inputs (voice input) and/or video inputs (gestures, movement or the like).

The term “control device” in the sense of the description encompasses an embodiment of a control system by means of which a directional influencing on the ground drilling device during operation, i.e. during the execution or for starting or stopping an earth borehole, is possible. In particular, the control device may be electric or electronic. The parameters entered by the operator can be used by the control device—if necessary converted and/or processed into electrical signals—as inputs for the operation of the ground drilling device. The ground drilling device can thus be operated or controlled by entering a parameter, which may have been converted into an electrical signal.

A “parameter” in the sense of the description is understood to be an input option with which a directional influencing of the operation of the ground drilling device is possible. The parameter can be relayed as an input signal to the control device, by means of which the control device controls the operation of the ground drilling device. For example, a parameter can cause a drilling operation to start with the ground drilling device or a drilling operation to stop with the ground drilling device. It is possible, for example, that an operator enters the parameter “Start” and a corresponding input signal linked to the input is relayed to the control device, which causes the drilling to start. Similarly, an operator can enter the parameter “Stop” and a corresponding input signal can be relayed to the control device, which will stop a drilling operation performed with the ground drilling device. Further parameters which influence or change the operation of the ground drilling device are possible, whereby these parameters can be entered by an operator and converted by the input device into an input signal and relayed to the control device.

The inputs, especially of a parameter, for the operation of the ground drilling device can be made by means of an input device. The term “input device” for the purposes of the description includes any electrical or electronic device which is capable of converting an input from an operator into an electrical signal which can be relayed to the control device without further processing or with the interposition of processing of the signal, in particular processing in one or more circuits, for example in an amplifier, in order to serve as an input or input signal of the control device. The input device can be understood as an interface between an operator and the control device. The input device may have a portable power supply, in particular in the form of one or more batteries, accumulators or similar.

In a preferred embodiment, the input device and the display device have separate power supplies. This enables increased flexibility. The power supply of the individual devices may be smaller than the power supply for the common power supply of the input device and the display device. In addition, the power supply of a conventional display device can be used.

In particular, the input device may include a processor which is designed as an arithmetic unit with electronic circuits to execute instructions. The processor can be programmed and is designed to process commands from within the system. The input device may have an operating system that can be modified, for example, to improve and/or adapt to changes in a ground drilling device. In particular, a change of the operating system can only be permitted if a password and/or the input device is connected to a computer interface, a dongle or similar. In particular, the processor can recognize, query, process and forward operator inputs in the form of parameters and/or process further commands of a program. The processor can run a program that requests or receives input from an operator, processes the operators input, makes settings for the operators input, transmits input to the controller and/or receives, processes and/or converts signals from the controller.

The input device may be functionally coupled to the control device. In this context, the term ‘functionally coupled’ in the sense of the description comprises a connection, in particular a unidirectional or bidirectional connection, of the said devices, in particular to provide signals from one of the devices, in particular the input device, and to receive and/or process received signals with the other device, in particular the control device. The functional coupling can be carried out directly or indirectly by interposition of further elements or devices.

In a preferred embodiment, the display device is connected (a) wirelessly or (b) by cable to the control device of the ground drilling device. This allows a certain mobility of the display device. In the case of a wireless connection, the mobility of the display device is increased with respect to the freedom of movement of an operator.

In a preferred embodiment, the display device is designed for wireless data exchange via WLAN. This allows the use of a data protocol or transfer protocol that is known and easy to handle. In particular, the data exchange between the display device and the control device of the ground drilling device may be separate from the data exchange between the input device and the control device of the ground drilling device. For example, for the exchange of data between the input device and the control device of the ground drilling device, a higher level of communication security can be achieved by using different frequency bands and/or transmission protocols.

In a preferred embodiment, some or all of the aforementioned parameters for the operation of the ground drilling device can be called up and/or represented by means of the display device—in addition to a display of the signals provided by the detection device, which may be processed or edited. The display can be designed in such a way that not all parameters are shown at the same time, but, depending on the operators input, one or more parameters are shown which the operator can select for display or which are considered important and/or necessary by a command sequence of the control device for the execution and/or input of a parameter. The display device can be coupled to the input device in such a way that—if the operator wishes to enter a parameter using the input device—parameters, data, information and/or notes related to this parameter are displayed on the display device. The display device may be designed in such a way that—if a changed or predetermined signal is detected by the detection device—a representation representing the detected state is displayed.

The display device may be designed in such a way that it can optionally be mechanically connected to an input device and/or the display device can be mechanically connected to a coupling on the ground drilling device. On the one hand, it may be possible for the display device and the input device to form a unit that can be handled together and held by one operator. On the other hand, it is also possible to connect the display device to the ground drilling device, for example to display the signals from the detection device in the operators station.

In a preferred embodiment, the display device and the input device are functionally coupled in such a way that when an input is made on the input device, the input is displayed by means of the display device. The input device can transmit a signal to the display device directly or indirectly via the control device of the ground drilling device, indicating which parameter is to be changed or entered with the ground drilling device, so that the display device shows the current value of the parameter and/or parameters related to the parameter. For example, when entering the parameter “Carry out drill string change” by means of the input device, the signal of the detection device, which is provided at the end in the area of the ground drilling device, can be displayed on the display device in response to this input.

In a preferred embodiment, the display device has an input area adjacent to the input device when the input device and the display device are connected. This makes it possible for the operator to make, additionally to the possibility to input entries by the input device, entries on the display device. In particular, the input on the display device may be an input to modify the information to be displayed on the display device. In particular, the type of presentation can be changed. It is possible to retrieve information concerning the ground drilling device. In addition, the input area provided on the display device allows a clear separation of the inputs that the operator can make. The inputs for changing, for example, the information to be displayed need not be provided on the input device; the input device can be limited to the input of the parameters necessary for the operation of the ground drilling device. The input can be made by means of a touch-sensitive display known from state-of-the-art technology.

In a preferred embodiment, the display device can be used to call up and/or display all the above-mentioned parameters for the operation of the ground drilling device. The display may be designed in such a way that not all parameters are displayed at the same time, but, depending on the operators input, one or more parameters are displayed which the operator can select for display or which are considered important and/or necessary by a command sequence of the control unit for the execution and/or input of a parameter.

In a preferred embodiment, the display device has a control unit that is designed for context-sensitive display of information on the display device. Thus it is possible that the display device can be coupled with the input device in such a way that—if the operator wishes to enter or enters a parameter by means of the input device—parameters, data, information and/or notes related to this parameter are displayed on the display device, for example, a value of a parameter for the operation of the ground drilling device, information related to the parameter and/or notes for the setting can be displayed by means of the control unit if it is important for the operator and/or the operator wishes to enter or change such a parameter. For example, if the operator enters a parameter using the input device, the control unit can be used to display the parameter influenced or changed by the operator, even during the change or entry. It is possible, for example, to use the input device to continuously decrease or increase a parameter whose value is shown on the display device. It is also possible that the control device communicates with the control unit to display information, a value for a parameter, notes and/or error messages. For example, the control device of the ground drilling device may inform the control unit of the display device when a rod section needs to be connected to the drilled drill string in order to continue drilling. Furthermore, states of the ground drilling device can be displayed which require an action of the operator.

In a preferred embodiment, the input device is designed as (a) wired and/or (b) wireless remote control. In a particularly preferred embodiment, the input device is a wireless remote control, which allows the operator to move the input device essentially freely without having to pay attention to a cable connecting the input device to the ground drilling device. A wired remote control offers the advantage of an essentially undisturbed transmission of signals via the cable.

A “remote control” in the sense of the description encompasses an electrical or electronic handheld device suitable for controlling the operation of the ground drilling device by entering a parameter at a distance from the ground drilling device. For the purposes of the description, “at a distance from the ground drilling device” is to be understood as meaning that direct input by means of a device attached to the ground drilling device is not necessary. In particular, an operator outside the operators station of the ground drilling device can control the operation of the ground drilling device by entering a parameter for the operation of the ground drilling device.

In a preferred embodiment, entering the at least one parameter is (a) a setting of a torque and/or speed of rotation applied to a drill string of the ground drilling device, (b) a setting of a linear advancing force and/or linear advancing speed applied to a drill string, (c) a setting of a percussion frequency of a percussion piston, (d) a setting of an impact amplitude of a percussion piston, (e) a setting of flow rate and/or pressurizing of drilling mud, (f) a changing of the drill string, (g) a lubricating of the drill string and/or (h) a changing of the drilling head type. The type of string can be taken into account. Especially in the case of a double drill string, the torque and/or speed can be selected independently for an inner drill string, so that for a double drill string both torque and/or speed can be set for inner drill string and/or outer drill string. Here, essentially any input can be made that may be relevant for the drilling operation of the ground drilling device. In addition to starting or stopping a drilling operation performed with the ground drilling device, the above-mentioned parameters can be transmitted to the control device.

In order to set a torque/speed applied to the drill string of the ground drilling device, the control device may relay a signal to the drive of the ground drilling device connected to the drill string, depending on the parameter entered by the operator using the input device, so that the torque/speed selected by the operator can be set. The parameter can be a signal corresponding to the torque/speed value. The setting of a linear advance of the drill string can be used to adjust both, the force or pressure and/or speed, with which the drive acts on the drill string connected to the drive. Setting the linear advance can also include whether the linear advance is a pulling or pushing force, i.e. whether the drill string is pulled or pushed through the ground. In this respect, the term advance includes both pulling and pushing the drill string in both directions, so that a pulling or pushing force can be applied to the drill string. The parameter can thus be a signal corresponding to the tensile or compressive force. When drilling a borehole in the ground, drilling mud, especially in the form of bentonite, can be used. The drilling mud can be led through the drill string and emerge in the front area of the drill string. A flow rate/pressure of the drilling mud can be set as a parameter, which can be adapted to the conditions in the soil. When drilling with a drill string, it is necessary to extend the drill string in the course of the earth borehole, whereby in particular further rod sections are connected to the drill string already drilled in the ground. For this purpose, an input may be required which allows a change of the drill string, i.e. the connection of a further rod section, especially from a rod section magazine, with the already drilled drill string. The parameter can therefore be an operation corresponding to the command “Now drill string change”. When changing the drill string, the drill string already drilled in the ground can be clamped to fix the axial and/or angular position of the already drilled drill string. Furthermore, entering the parameter may involve changing the type of drill head, which may be necessary especially if, after a pilot hole has been drilled, i.e. a first borehole created by pushing in the ground, for example, the drill head type is changed into an widening drill head which is pulled through the previously created pilot borehole to widen it.

If the ground drilling device is designed as a percussion drilling device, the impact frequency of the percussion piston of the percussion drilling device and/or the impact amplitude of the percussion piston of the percussion drilling device can be adjusted. The term “percussion drilling device” or “earth rocket”, which is used essentially synonymously with the term “percussion drilling device”, includes, for the purposes of the description, a self-propelled percussion device which displaces soil and can percussively drive a pipe or tube into the ground. In this context, the term percussion drilling device may encompass ground drilling devices in which the drilling head tip is arranged in a housing with longitudinal movement. The tip of the drill head may be in particular a drill bit. A percussion drilling device can be either a single-stroke device or a multi-stroke device. In a one-stroke device, the percussion piston hits the tip of the drill head and at the same moment the housing. In a multi-stroke device, in particular a two-stroke device, the percussion piston first strikes the tip of the drill head, which thus advances in the first stroke. The housing is impacted by the percussion piston in a following cycle, especially in a second cycle. In a multi-stroke device, peak resistance and skin friction can be separated from each other and thus more easily overwound.

In a preferred embodiment, the input device has at least one mechanically actuated actuating element. The mechanically operated actuating element can be any mechanically or manually operated actuating element. A rotary actuator, a control stick and/or a pushbutton are preferred embodiments of a mechanically actuated actuating element. Different kinds of actuating elements are possible on the input device.

A control stick in the sense of the specification is an actuating element for the entering of two-dimensional signals in particular. A control stick may comprise an element extending from a surface, which can generally be tilted in multiple directions. The element can be configured in particular as a rod, a piston, a stick, or a lever. The element can extend from a surface at a height not greater than 7 cm, preferably 6 cm, preferably 5 cm, preferably 4 cm, preferably 3 cm, preferably 2 cm, preferably 1 cm. The diameter of the element may in particular be less than 5 cm, preferably 4 cm, preferably 3 cm, preferably 2 cm. A control stick in the sense of the specification may also be called an analog stick or a joy stick and it may be equivalent in function to this. The term control stick also encompasses a control pad with which an entry of two-dimensional signals is possible. The control stick may generate a signal which is dependent on the position of the element or the control pad in relation to a standard or resting position of the element or the control pad. It may be provided that the control stick provides individual electric signals when activated and/or continuously provides an electric signal in the form of voltages and/or currents, wherein a potentiometer can be used respectively for one of the dimension in which the element or the control pad can be tilted, for example one potentiometer for the up/down position and one potentiometer for the left/right position. The voltage can change due to the change in position or attitude of the element or control pad of the control stick in relation to the resting or standard position. The size and/or arrangement of the control stick on the input device may be adapted such that an activation is possible by means of the thumb or a finger of an operator, in particular an activation of the control stick is possible without grabbing the control stick. Insofar as the control stick is designed to generate signals in dependence on a movement in at least two dimensions, this also includes the possibility that an entry can be provided for a control of the operation of the ground drilling device by means of a control stick in which the control stick generates no signals in regard to the movement in one of the dimensions and/or signals in regard to the movement in one of the dimensions are not taken into account, or do not need to be taken into account by the control device.

A rotary switch or rotary knob in the sense of the specification may comprise a potentiometer or be formed by such. Advantageously, the rotary switch is substantially maintenance-free and not sensitive to vibrations; moreover, in the switched-off state, a turning of the rotary switch has no effect.

A pushbutton in the sense of the specification is an actuating element which can be configured as a subassembly which makes or breaks an electrically conductive connection. The pushbutton may be designed as a toggle switch or a simple pressure switch. It has been found to be advantageous for the operating stroke of a pushbutton to be at least more than 2 mm, in order to count as a “wanted” activation. Preferably, actuating strokes of more than 2.3 mm are used, and when gloves are worn then actuating strokes of more than 3 mm, preferably more than 5 mm, particularly preferably more than 6 mm, even further preferably more than 7 mm may be provided. For the diameter of a pushbutton, it has been found to be advantageous for the diameter of the pushbutton to be more than 5 mm, particularly more than 7 mm, for an activation by means of the finger of the operator. For an activation by means of the thumb of the operator, the diameter of the pushbutton can advantageously be more than 15 mm, preferably more than 17.5 mm, particularly more than 20 mm.

A selection of mechanically operated actuating elements may be provided at the input device. In particular, customary actuating elements of the prior art can be used to allow the operator the also customary input options for the control of the ground drilling device. The size and/or arrangement of the actuating elements may vary relative to the prior art, in particular a control stick on the input device may be smaller than a multifunction joystick situated in the operator's station.

In one particularly preferred embodiment, the input device may comprise at least one capacitive or mechanically operated actuating element and/or a radio transmitter, particularly to determine whether an operator entrusted with operation of the ground drilling device is holding the input device or grasping it with his hands. Accordingly, an actuating element and/or a radio transmitter may be provided to determine whether an operator can operate the input device or is located in its near field. A capacitive or mechanically operated actuating element can recognize the presence of the operator as well as a radio transmitter. For example, a mechanically operated actuating element can determine whether the operator is operating the respective actuating element in order to allow data entry and/or further operating of the ground drilling device and not to place it in a protected condition. For example, it may be provided that the entry of a parameter only occurs when the respective actuating element has positively recognized that the operator is holding the input device or grasping it with their hands or is operating the actuating element at the same time. In this way, it is possible to determine for example whether the operator has set the input device aside, for example in order to perform work on the ground drilling device or gain access to it, while the ground drilling device is still performing an earth drilling and driving the drill string. In such an event, a switching off or a placing of the ground drilling device in a resting condition can be done. The input device may in such a case relay to the control device a signal corresponding to a parameter signifying, in a real instruction, “Produce resting condition” or “Emergency shut off”. It may be provided that the “resting condition” of the ground drilling device differs from the condition of the ground drilling device after an “emergency shut-off”; in an “emergency shut-off”, a shutting off of the ground drilling device may occur, whereas in a “resting condition” the units and/or drives of the ground drilling device continue to be switched on but are not driven.

In one preferred embodiment, the sensitivity of the mechanically operated actuating element can be adjusted a) mechanically and/or b) by means of software, which is functionally coupled by means of a sensor and a corresponding element to the actuating element. This can create the possibility for the operator to adjust the sensitivity, particularly that of a control stick or a rotary switch, even under different conditions, such as with or without wearing gloves. For example, two different settings are possible for the sensitivity of a control element: 1) operation with gloves or 2) operation without gloves. It may also be provided that the sensitivity can be set in dependence on the kind of the entry or the parameter. The setting can be undertaken by the processor in the input device.

In one preferred embodiment, the input device comprises at least one particularly two mechanically operated actuating elements, particularly one or two pushbuttons, which are present on the input device at least so far apart that a two-hands operation is required. This can create a so-called dead man's switch, with which it can be verified that an operator is present or able to act. If it is recognized that no operation of one of the actuating elements is done, then it may be concluded that the operator is not present and/or capable of acting, so that a signal or a switching action may be triggered. This can achieved a higher degree of safety during the operation of the ground drilling device. For example, an operator may be prompted by means of a haptic signal, a visual indication, and/or an acoustic signal, to operate the actuating element or both of them; if no operation occurs, a signal or a switching action may be triggered, which switches the ground drilling device to a resting state or switches it off. The providing of two mechanically operated actuating elements, only one of which need be used as a so-called dead man's switch, can provide the advantage that—when the mechanically operated actuating elements are present both right and left on the input device—the input device can be easily and ergonomically operated by both right-handed and left-handed operators. Accordingly, it will be sufficient to configure a dead man's switch either on the left or the right side. However, the providing of the two options, both right and left, takes account of the possible requirements of the operator.

The input device may have a circumferential outer contour, particularly an interrupted or closed one, which may enclose an inner contour or interior of the input device. The circumferential outer contour may be substantially rectangular, square, polygonal, round, circular and/or elliptical over the entire area or also only for a portion. Mixed shapes and combinations of the mentioned shapes are possible. In particular, it may be provided that the input device is substantially rectangular or cuboidal and has a dimension in the range of 15 cm to 50 cm in width, preferably 20 cm to 40 cm in width, 10 cm to 30 cm in length, preferably 15 cm to 25 cm in length, and 3 cm to 15 cm in height, preferably 5 cm to 10 cm in height.

It may be provided that the input device has at least one protrusion or multiple protrusions, particularly two of them, particularly in regard to one of the aforementioned shapes, which may be adapted for grasping by means of the hands of the operator, in particular, the protrusion or the protrusions may be configured as a handle. Preferred is a handle configuration which can be embraced by one hand of the operator. The protrusion or the protrusions may project beyond the rectangular, square, polygonal, round, circular and/or elliptical shape of the input device. The mechanically operated actuating elements in particular can be fashioned on one of the protrusions or on each of them. The protrusions may be configured on the input device such that a surface facing toward the operator results by means of the protrusion or the protrusions, forming a surface which can lie in a plane in particular. It may be provided that the protrusions stand off from a surface with the aforementioned shape, particularly to form entirely or partially a holder, particularly one with the circumferential outer contour, for an indicator device as described below in the specification. The protrusion or protrusions may stick out from a base surface or a base plate. The protrusion or protrusions may form, at least for a portion, an edge on a base plate having an aforementioned shape. The protrusion or protrusions may be offset forwards in relation to the base plate. If multiple protrusions are present, the protrusions may project in the same direction relative to a base surface or base plate and form an edge thereon. The base plate with the protrusion or protrusions may follow in particular a circumferential outer contour of an indicator device. The base plate can be entirely closed or it may have apertures. A wall may project at least partly or in closed manner at the edge on the base plate, which can enclose at least partially or entirely on the circumference of an indicator device described hereafter in the specification.

A curved adaptation of the protrusions to the shape of the hands of the operator is possible, particularly as regards the corners of a protrusion. The particular protrusion may be adapted to the dimensions of the hand of the operator; in this way, the input device may be configured in other areas independently of the hands of the operator; it is possible for an adaptation to the dimensions and shape of the hands to be present only in the area of the protrusions. Thus, an adaptation to the dimensions and/or shape of the hands of the operator, possibly involving a smaller structural shape, may only pertain to the protrusions.

The mentioned protrusion or protrusions for a good grasping by means of one hand of the operator may have a diameter in the range of 3 cm to 5 cm, preferably 3 cm to 4 cm. The length of a protrusion particularly for a good holding by one hand of the operator, particularly in a manner not causing fatigue, may be larger than 10 cm, preferably larger than 15 cm, in order to allow for the possibility of the operator wearing a glove, for example.

If more than one protrusion is formed on the input device, the protrusions may be formed on opposite sides of the input device. A mirror image symmetry of the protrusions is possible. The mechanically operated actuating elements can be formed as mirror images of each other on the protrusions when multiple protrusions are provided.

When the respective protrusion is grasped by the hand of the operator as intended, a control stick may be arranged on the protrusion in the area of the thumb. Preferably, a control stick is arranged on each of the protrusions in the area of the thumb. Preferably, a mechanically operated actuating element fashioned as a control stick element protrudes from a substantially flat or noncurved surface. The control stick may protrude from a surface of the input device facing toward the operator. In particular, a control stick may protrude from a surface parallel to the base surface of the input device, which can be established basically by the circumferential outer contour.

If a control stick is provided on the input device, a further mechanically operated actuating element, particularly a rotary switch, can be arranged on a surface of the protrusion different from the surface for the control stick. Regardless of whether a control stick is provided, a rotary switch can be arranged in particular on a surface of the protrusion extending away from the operator. The surface on which a rotary switch is arranged can make an angle in particular with a surface facing toward the operator when holding the input device or on which a control stick is provided of 10° to 60°, preferably 20° to 50°. In particular, the rotary switch may be arranged such that it can be comfortably operated with the index finger or middle finger of the operator when the input device is held, particularly if the operator grasps the protrusion optionally provided on the input device.

If a control stick is provided on the input device, a pushbutton may be arranged in particular on a surface different from the one provided for the control stick. A pushbutton may be arranged in particular on a surface of the protrusion extending away from the operator when the input device is held. The surface on which the pushbutton may be provided can be opposite the surface from which the control stick extends, if a control stick is provided. The surface on which the pushbutton is arranged can make an angle with a surface on which a control stick is provided of 10° to 60°, preferably 20° to 50°. The pushbutton may be arranged in particular so that it can be comfortably operated with the index finger, middle finger, or ring finger of the operator when the operator is holding the input device, particularly when the operator is grasping the protrusion possibly provided.

It may be provided that a pushbutton and a rotary switch are present on the same surface at a distance from each other, wherein an operation with different fingers of the operator is possible in particular.

Basically three surfaces may be formed on a protrusion of the input device, on which a mechanically operated actuating element can be arranged each time. The surfaces on which a mechanically operated actuating element is provided can make an angle with each other. The surfaces may have a curvature. A mechanically operated actuating element designed as a rotary switch may be arranged preferably on a surface having a curvature, and the curvature of the surface may basically correspond to the curvature of the rotary switch, so that an operation of the rotary switch can occur in particular over an angle range which is larger than 180°, larger than 190°, larger than 200°, larger than 210°, larger than 220°, larger than 230°, larger than 240°, larger than 250°, larger than 260°, larger than 270°, larger than 280°, larger than 290°, larger than 300°. Thus, an operating of the rotary switch can be easily done by an operator who may be wearing gloves.

A mechanically operated actuating element designed as a pushbutton may be arranged preferably on a surface having a curvature. A pushbutton may have a curvature basically corresponding to the curvature of the surface. It may be provided that an operation of the pushbutton is possible over a large angle range, which may correspond to the angle range of the curvature. An actuation may occur even if the pushbutton is not operated in a straight line.

A structuring of the input device is possible for at least partial or complete accommodation of a further device, particularly an indicator device described below in the specification, wherein an accommodating in the sense of the specification involves the possibility of a connection between the two devices, particularly the input device and the indicator device, which may be with form fit and/or force locking, in particular.

In one preferred embodiment, the input device has an inner contour which is adapted to the outer contour of the indicator device, and the input device surrounds the indicator device at least partly along a section of the outer contour of the indicator device. In this way, a connection can be created between the input device and the indicator device whereby the indicator device is at least partly surrounded by the input device. The indicator device may be provided inside the input device, where the term “inside” also encompasses the case where the input device does not entirely enclose the indicator device. A substantially central arrangement of the input device around the indicator device is possible. In particular, the input device may contact the indicator device on one, two, three or four sides. A form fit and/or a frictional locking can be formed between the indicator device and the input device. In particular, the form fit—as well as the friction locking—may be optionally released in order to separate the mechanical connection.

In one preferred embodiment, the input device has a not necessarily flat surface on which at least two actuating elements are arranged in the area of two neighboring corners and/or opposite edges. The corners and/or edges may also be formed on one or more protrusions. This makes possible an ergonomically favorable arrangement of two actuating elements for the person performing the operation. Thus, the principles of an optimal design can be satisfied. Designs conforming to occupational medicine, user friendliness, work science or personal body type of the operator can be taken into account.

In a particularly preferred embodiment, the input device can be grasped in the area of the corners and/or the edges—possibly in the area of a protrusion—by one hand of the operator. Moreover, in the preferred embodiment, at least one actuating element can be arranged so that it can be reached by one finger or the thumb of the user, grasping the corners and/or the edges—possibly at one or more protrusions. It has been discovered that an optimal adaptation is achieved from an ergonomic standpoint, also taking account of work science and user-friendly criteria. For example, the input device may be adapted by the thickness of the corners and/or edges to the operator's hand, taking into account whether or not the operator is wearing gloves.

In particular, the actuating elements arranged in the area of the corners and/or edges may be control sticks. In particular, the control sticks may be arranged on a surface of the input device forming a base surface or situated in parallel with this.

In one preferred embodiment, the input device is adapted to use one or more radio bands for the communication with the control device of the ground drilling device. In the sense of the specification, a frequency band means frequency ranges, i.e., partial ranges of the electromagnetic spectrum of electromagnetic waves used for technical communication. It is usual to partition this spectrum by frequency, wavelength, or usage. Different designations of frequency bands are possible, particularly international ones.

In one preferred embodiment, the input device comprises one or more antennas, in order to provide signal pathways, particularly in a direction to heighten the operating safety of the ground drilling device, for example. It may be provided that a bidirectional transmission of signals is possible by means of an antenna between the input device and the control device. But it may also be provided that at least one antenna is provided for one direction (from the input device to the control device and from the control device to the input device) and different antennas are used for the two directions. The antenna(s) may be connected to the processor of the input device.

A bidirectional communication between the input device and the control device is possible. For example, the control device may confirm the entering of a parameter or relay to the input device the fact that an error has occurred in the entering and/or transmittal to the control device.

In one preferred embodiment, the ground drilling device comprises one, two, or more antennas for the communication with the input device. The ground drilling device can use in particular the signal which is the strongest, the best, or the most stable, by means of the control device.

In one preferred embodiment, one or more antennas are arranged on the ground drilling device for the communication with the indicator device. The use of two antennas in particular on the ground drilling device affords the possibility that the signal of the control device of the ground drilling device which is the best, most stable, or strongest signal on the particular antenna can be used each time. When using multiple antennas, interference can be minimized or even precluded. In one preferred embodiment, an antenna may be present at the indicator device, particularly an integrated one. In order to boost the range, in one preferred embodiment a further or additional antenna can be screwed onto the indicator device. The possibility of a boosted range is particularly attractive when the operator is located very far from the ground drilling device along the drilling route. It may also be provided to have multiple antennas on the indicator device, each time picking off a signal from them which is the best, most stable, or strongest.

In one preferred embodiment, the input device has a status display to indicate a state. The status display may be connected to the processor. The status display may involve a state regarding a power supply of the input device, a transmission of data and/or signals from the input device to the control device, a signal strength, an indication that the input device has been switched on or off, and/or an error message. The status display may be reduced to the essential information, so that for example a display only occurs when a particular state is reached—such as a critical one. For example, the status display may be adapted to identify a reduced power supply or a power supply of the input device tending to decline in the near future. Alternatively or additionally, it may be provided that the status display indicates that an error has occurred during the transmittal of data from the input device to the control device. Alternatively or additionally, the status display can indicate that the signals generated by an actuating element are defective. Alternatively or additionally, the status display can indicate that an error has been found at the ground drilling device or the control device, particularly one in the form of a signal of a device monitoring a critical state. The status display may be a clear text display, a simple lighting means, particularly a LED, which may be colored. In the case of a simple lighting means, the color of the lighting means may correspond to the state being displayed to the operator. For example, the color may change or a different colored lighting means may be actuated or become lit if the type of condition or the condition changes. For example, it may be provided that, when the ground drilling device is in operation and no error has been detected, a green light is used. If the condition changes in the way of a worsening, for example the power supply has been reduced below a certain degree in terms of its capacity, the color orange may be used. A further reduction or an error may be signaled with the color red. In the area of the status display or as part of the status display, a symbol may be situated or represented, particularly in the form of an imprint, providing information about the status display. For example, a battery symbol may be used for the status display regarding a power supply. An antenna symbol may be used for a status display regarding a transmission error.

In one preferred embodiment, the input device has an attachment for a carrying strap of an operator, so that the operator is relieved of holding the weight of the input device. More comfortable working is possible, more free of fatigue. It may also be provided that the attachment by means of a carrying strap can be used to carry the input device. The operator can let go of the input device and the input device will still be attached to the operator, for example, on a carrying strap fashioned as a shoulder, neck, or waist strap.

In one preferred embodiment, the input device comprises an element of a connection pair, which can interact mechanically and/or electrically with a further element of the connection pair which is situated at the ground drilling device. The connection pair may be a pair of elements forming a mechanical and/or electrical connection. The input device can be held securely on the ground drilling device by means of the mechanical connection. By means of an electrical connection, for example, a signal transmission and/or a power transmission is possible. A charging of the battery or the power supply of the input device is possible. The further element of the connection pair may be present in particular at the driver's station at the ground drilling device. By means of the further element of the connection pair at the driver's station, it is possible to use the input device at a fixed position of the ground drilling device, with which the operator is familiar, and where the operator is basically protected against environmental factors.

The invention also creates a method for controlling the operation of a ground drilling device which moves a drill string for drilling an earth borehole in the ground. The drill string is detected at the end (a) in the region of the ground drilling device and/or (b) in the region of a target pit of the earth borehole to be introduced.

The invention also provides for the use of a ground drilling device for moving a drill string for the insertion of an earth borehole into the ground: A detection device is used which is designed to detect the drill string at the end (a) in the region of the ground drilling device and/or (b) in the region of a target pit of the earth borehole to be inserted.

In a preferred configuration, the detection device has communication means for transmitting data and/or signals between the detection device and a drill head location acquisition system. In addition to the parameters and information that are displayed on the display device for the operation of the ground drilling device, it is also possible to show on the display device where in three-dimensional space the drill head of the drill string was detected by the location acquisition system. The control unit can thus be designed to process the signals of a location acquisition system and to use them to display the current or determined location of the drill head. This display can be done in different ways. A pictorial representation in one, especially selectable, map, which can be three-dimensional or two-dimensional, is possible. It may be provided that the locating acquisition system does not transmit the data directly to the display device, but transmits the data to a gateway, which in particular collects all data not only the locating acquisition data, but also the operational data and the drilling data that are recorded. The gateway, in turn, can then send the location acquisition data and also other data that is collected to a cloud. From here they can be called up, evaluated and transmitted. The display device is designed for data evaluation. Where it is described that the display device has communication means for transmitting data and/or signals between the display device and a location acquisition system, this also means that the display device can retrieve and/or evaluate this data, for example by retrieving it from the cloud. Alternatively or additionally, it is possible that the location acquisition data can also be sent directly from the gateway to the display device—without interposing a cloud—or directly from the location acquisition system.

The invention is described with respect to three aspects concerning a system, a method and a use. The explanations on the individual aspects complement each other, so that the explanations for the system should also be understood as explanations of the description for the method and use. The description of the system shall also include any acts relating to the method or method steps concerning the method and uses or features with regard to the use which apply to the aspects concerned.

For the purposes of the description, the naming of a numerical value, in particular a length specification or an angle specification, includes not only the actual numerical value, but also—in order to take into account manufacturing tolerances in particular—a range around the concrete numerical value, which can be +/−15%, preferably +/−10%, of the specified numerical value.

The above explanations, as well as the following description of exemplary designs, do not constitute a waiver of certain designs or features.

### BRIEF DESCRIPTION OF DRAWINGS

The invention is explained in more detail in the following on the basis of an embodiment shown in the figures. The drawings show:

FIG. 1A a schematic sectional view of an earth borehole using a ground drilling device;

FIG. 2A a schematic view of the ground drilling device with an input device;

FIG. 3A a schematic view of the input device and a display device;

FIG. 4 the display device and the input device from above; and

FIG. 5 the display device and the input device from below.

### DETAILED DESCRIPTION

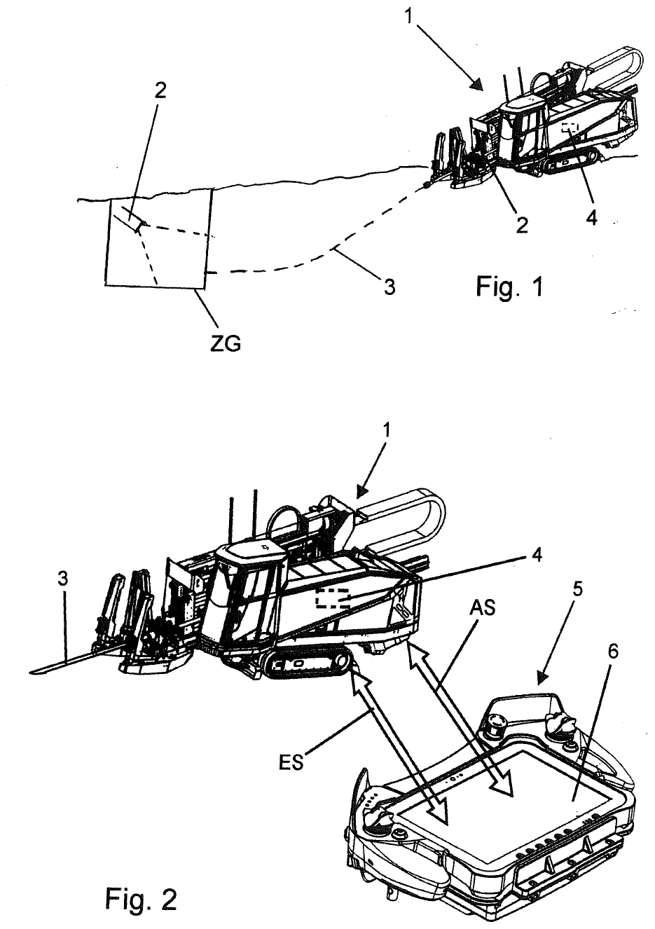

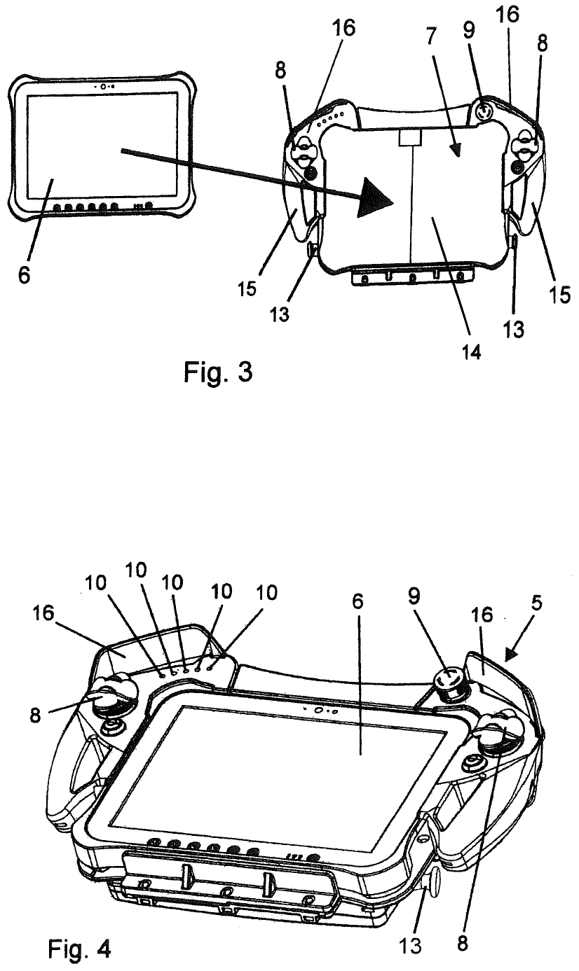

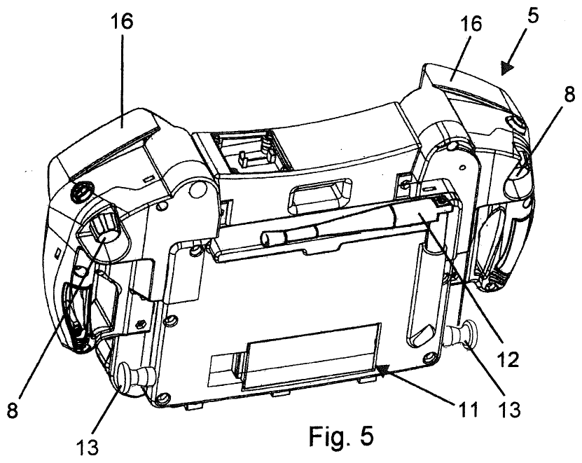

FIG. 1 shows a schematic view of a ground drilling device 1, with which an earth drilling can be carried out into the ground. A drill string 3 is moved through the soil.

Detection devices 2 are provided, which are designed to detect the drill string 3 at the ends, firstly in the region of the ground drilling device 1 and secondly in the region of a target pit ZG of the earth borehole to be drilled.

In the embodiment shown, the detection devices 2 are each designed as one camera.

The ground boring device 1 has a control device 4 for the operation of the ground drilling device 1, which is schematically visualized by the dotted box on the ground drilling device 1. By means of the control device 4 the operation of the ground drilling device 1 can be controlled.

In addition, there is an input device 5 functionally coupled to the control device 4, which is designed to enter at least one parameter for the operation of the ground drilling device 1 (see FIG. 2). In particular, such a parameter may cause drilling with the ground drilling device 1 to be started or drilling with the ground drilling device 1 to be stopped. The input device 5 is designed as a remote control which communicates wirelessly with the control device 4 by means of electromagnetic waves.

Wireless communication between input device 5 and control device 4 is a bidirectional communication in which input device 5 both receives signals from control device 4 and sends signals to control device 4. The bidirectional wireless communication is visualized by double arrow ES.

As can be seen in FIG. 1, among other things, the ground drilling device 1 has a rod magazine in which rod sections are stored with which the drill string 3, which has already been drilled into the ground, can be extended.

A display device 6 is also provided to show information and/or parameters for the operation of the ground drilling device 1. In particular, signals from the detection device 2 can be displayed on the display device 6. For the representation of the information, signals and parameters, the display device 6 is functionally coupled with the control device 4 and/or the detection device 2. The communication between the display device 6, the control device 4 and/or the detection device 2 is wireless using electromagnetic waves. The communication is bidirectional so that the display device 6 can receive signals from the control device 4 or the detection device 2 as well as transmit signals to the control device 4 or the detection device 2. The bidirectional communication is visualized by means of double arrow AS.

As can be inter alia seen in FIG. 2, the display device 6 can be arranged in a receptacle 7 of the input device 5 in such a way that the display device 6 together with the input device 5 can be handled as a unit by one operator.

The input device 5 has several mechanically operated actuating elements 8, two of which are designed as control sticks. Furthermore, the input device 5 has an emergency stop switch 9 as a mechanically operated actuating element 8, which is designed as a push button. The actuating elements 8 designed as control sticks and the emergency stop switch 9, face an operator when holding the input device 5 and are located in one plane of the input device 5. Opposite the surface on which the control sticks and the emergency stop switch 9 are arranged, two rotary actuators are designed as mechanically actuated actuating elements 8 on the left and right of the input device 5.

On the left side of the input device 5, several status indicators 10 are provided, which give an indication of the status of the input device 5, the ground drilling device 1 and/or a communication between the input device 5 and the control device 4.

Furthermore, the input device 5 has a compartment 11 provided on the underside of the input device 5 for the arrangement of a power supply for the input device 5.

A swiveling antenna 12 is provided for wireless communication with the control unit 4, which can be swiveled with respect to its orientation and its length can be changed telescopically.

To protect the operation of the mechanically actuated actuating elements 8, a protective elevation 16 is provided on the input device 5, which is located in the area of the emergency stop switch 9 and the control sticks.

For attaching a neck, shoulder or hip belt, connecting elements 13 are provided with which the corresponding belt can be connected.

The input device 5 has a base plate 14, which is essentially rectangular in shape, to accommodate the display device 6 (see FIG. 1). The mechanically actuated actuating elements 8 are formed on handle-like projections 15 of the base plate 14, which can each be grasped by one hand of an operator to perform the actuation. The protrusions 15 extend in an upward direction and form a rim around the base plate 14. The projections 15 form a border on one side of each. The two edges formed by projections 15 are opposite each other. On the other two sides of the rectangular base plate 14 there are further edge sections which extend upwards in the same direction as the edges formed by projections 15. This creates an edge at least partially surrounding the base plate 14, in which the display unit 6 can be arranged. A force closure may be formed in which case, at the edges formed by the projections 15, the indicator 6 at least partially engages the projections 15 from behind.

1. A system comprising a ground drilling device for moving a drill string for the introduction of an earth borehole into the earth, wherein a detection device is adapted to detect the drill string at the end in the region of the ground drilling device and/or in the region of a target pit of the earth borehole to be created.

2. The system according to claim 1, wherein the detection device is a camera, an zone scanner and/or a motion scanner.

3. The system according to claim 1, further comprising a display device for displaying a state detected by the detection device, wherein the detection device comprises a transmitter and the display device comprises a receiver, and wherein the display device is adapted to process signals for representing the state detected by the detection device.

4. The system according to claim 3, wherein the display device is configured for wireless transmission of signals.

5. The system according to claim 3, wherein the display device is a tablet, iPad, notepad, or smart display.

6. The system according to claim 3, wherein the display device comprises one element of a pair of connections which can cooperate mechanically and/or electrically with a further element of the pair of connections which is arranged on the ground drilling device.

7. The system according to claim 3, wherein the display device comprises a controller which is designed for context-sensitive display of information on the display device.

8. The system according to claim 1, further comprising an input device for inputting at least one parameter for the operation of the ground drilling device including a parameter which causes a start of the earth drilling with the ground drilling device or a stop of an earth drilling carried out with the ground drilling device.

9. The system according to claim 8, wherein the input device is a remote control.

10. The system according to claim 8, wherein the input device has an inner contour adapted to the outer contour of the display device, and the input device surrounds the display device at least partially along a portion of the outer contour of the display device.

11. A method for controlling the operation of a ground drilling device which moves a drill string for drilling an earth borehole in the ground, comprising detecting by a detection device the drill string at an end thereof in the region of the ground drilling device and/or in the region of a target pit of an earth borehole to be drilled.

12. (canceled)
